(19) United States
(12) Patent Application Publication
(10) Pub. No.: US 2024/0066841 A1
(43) Pub. Date: Feb. 29, 2024

(54) LAMINATE FOR SEALING MATERIALS, SEALING MATERIAL, AND BATTERY

(71) Applicant: UCHIYAMA MANUFACTURING CORP., Okayama (JP)

(72) Inventors: Otone ESUMI, Okayama (JP); Yuji YASUFUKU, Okayama (JP); Takami KAWABATA, Okayama (JP)

(21) Appl. No.: 18/452,170

(22) Filed: Aug. 18, 2023

(30) Foreign Application Priority Data
Aug. 24, 2022 (JP) 2022-133570

(51) Int. Cl. B32B 19/04; B32B 25/20; H01M 10/658; H01M 50/204; H01M 50/24

(52) U.S. Cl. CPC B32B 19/043; B32B 25/20; H01M 10/658; H01M 50/204; H01M 50/24; B32B 2250/02; B32B 2250/40; B32B 2262/105; B32B 2262/108; B32B 2307/3065; B32B 2307/7376; B32B 2457/10

(57) ABSTRACT

A laminate for sealing materials which includes: a first layer that contains a flame-retardant silicone rubber compound; and a second layer that contains a fiber-based flame retardant, in which a content of an organic component in the second layer is 0 to 10% by weight.

### CROSS-REFERENCE TO RELATED APPLICATION

This application is based on Japanese Patent Application No. 2022-133570 filed with the Japan Patent Office on Aug. 24, 2022, the entire content of which is hereby incorporated by reference.

### BACKGROUND

### 1. Technical Field

An aspect of the present disclosure relates to a laminate for sealing materials, a sealing material, and a battery.

### 2. Related Art

In the past, a technology to dispose a flame-retardant layer on a substrate in order to impart flame retardancy to an article has been proposed (see, for example, JP-A-2016-141728 and JP-A-2009-001012).

### SUMMARY

A laminate for sealing materials which includes: a first layer that contains a flame-retardant silicone rubber compound; and a second layer that contains a fiber-based flame retardant, in which a content of an organic component in the second layer is 0 to 10% by weight.

### BRIEF DESCRIPTION OF DRAWINGS

FIG. 1 is a schematic view illustrating an example of an outline structure of a laminate for sealing materials according to an aspect of the present disclosure;

FIG. 2 is a schematic view illustrating a modification example of an outline structure of a laminate for sealing materials according to an aspect of the present disclosure;

FIG. 3 is a schematic view illustrating another example of an outline structure of a laminate for sealing materials according to an aspect of the present disclosure;

FIG. 4 is a schematic view illustrating another modification example of an outline structure of a laminate for sealing materials according to an aspect of the present disclosure; and

FIG. 5 is a schematic view illustrating an example of a battery that includes a sealing material according to an aspect of the present disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Silicone rubber used in a sealing material is also required to have flame retardancy in some cases depending on its use. The present inventors conducted research and found that existing silicone rubber has room for further improvement from the viewpoint of flame retardancy.

An aspect of the present disclosure has as its object to provide a laminate for sealing materials having more improved flame retardancy than in the past.

A laminate for sealing materials according to an aspect of the present disclosure includes: a first layer that contains a flame-retardant silicone rubber compound; and a second layer that contains a fiber-based flame retardant, in which a content of an organic component in the second layer is 0 to 10% by weight.

According to an aspect of the present disclosure, there is provided a laminate for sealing materials having more improved flame retardancy than in the past.

Hereinafter, embodiments of the present disclosure will be described in detail. However, the technology of the present disclosure is not limited to the following embodiments, which can be variously modified within the described scope. An embodiment in which the technical measures disclosed in different embodiments are appropriately combined also falls within the technical scope of the present disclosure.

As described herein, the expression “A to B” which represents numerical value range denotes “A or more and B or less”.

### <<1. Laminate for Sealing Materials>>

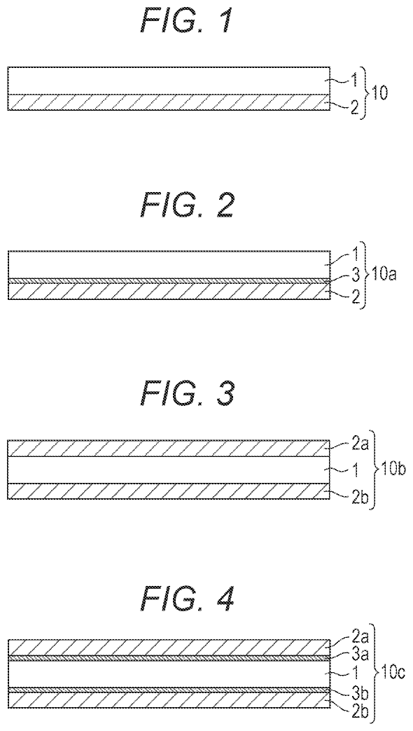

FIG. 1 is a schematic view illustrating an example of an outline structure of a laminate for sealing materials according to an aspect of the present disclosure. A laminate for sealing materials 10 (sealing material 10) includes a first layer 1 and a second layer 2. Hereinafter, the second layer 2 and the first layer 1 will be described in this order.

### [1.1. Second Layer]

The second layer contains a fiber-based flame retardant. The content of an organic component in the second layer is 0 to 10% by weight.

### (Fiber-Based Flame Retardant)

The fiber-based flame retardant represents a flame retardant in a fibrous form. As described herein, the “fibrous form” refers to a shape having an aspect ratio (length/diameter) of 3 or more.

The lower limit of the average fiber length of the fiber-based flame retardant is preferably 50 μm or more, more preferably 70 μm or more, and further preferably 100 μm or more. The upper limit of the average fiber length of the fiber-based flame retardant is preferably 1500 μm or less, more preferably 1000 μm or less, and further preferably 800 μm or less. The lower limit of the average diameter of the fiber-based flame retardant is preferably 0.05 μm or more, more preferably 0.1 μm or more, further preferably 0.15 μm or more, and particularly preferably 0.2 μm or more. The upper limit of the average diameter of the fiber-based flame retardant is preferably 10.0 μm or less, more preferably 5.0 μm or less, further preferably 3.0 μm or less, and particularly preferably 1.0 μm or less. The lower limit of the aspect ratio is preferably 5 or more, more preferably 50 or more, further preferably 100 or more, and particularly preferably 150 or more. The upper limit of the aspect ratio is preferably 5000 or less, more preferably 4000 or less, further preferably 1000 or less, particularly preferably 500 or less, and further more preferably 250 or less.

Examples of the fiber-based flame retardant include artificial mineral fiber and natural mineral fiber. That is, the fiber-based flame retardant preferably contains one or more selected from the group consisting of artificial mineral fiber and natural mineral fiber. Examples of the artificial mineral fiber include rock wool, stone wool, slag wool, mineral wool, glass wool, mineral glass wool, alkali earth silicate wool (AES wool), and alumina fiber. Examples of the natural mineral fiber include wollastonite and potassium titanate fiber. Among these, artificial mineral fiber is preferable. Of the artificial mineral fiber, one or more selected from the group consisting of AES wool, rock wool, and alumina fiber is preferable. In an embodiment, the fiber-based flame retardant is an inorganic substance. In an embodiment, the fiber-based flame retardant is not asbestos.

The lower limit of the content of the fiber-based flame retardant in the second layer, with respect to the total weight of the second layer, is preferably 5% by weight or more, more preferably 10% by weight or more, and further preferably 20% by weight or more. The upper limit of the content of the fiber-based flame retardant in the second layer, with respect to the total weight of the second layer, is preferably 70% by weight or less, more preferably 60% by weight or less, and further preferably 50% by weight or less. When the content of the fiber-based flame retardant is within the above-described range, sufficient flame retardancy tends to be imparted to the laminate for sealing materials.

### (Organic Component)

The second layer may contain an organic component. The organic component functions as, for example, a binder for molding the fiber-based flame retardant into a sheet shape.

The upper limit of the content of the organic component in the second layer, with respect to the weight of the second layer, is 10% by weight or less and preferably 8% by weight or less. The upper limit of the content of the organic component in the second layer, with respect to the weight of the second layer, can be 0% by weight or more, 1% by weight or more, or 2% by weight or more. In this manner, it can be said that the second layer is a layer in which the content of an organic component is small. The provision of such a second layer can improve flame retardancy of the laminate for sealing materials.

The content of an organic component in the second layer can be estimated from the ignition loss of the second layer. In an embodiment, the content of an organic component in the second layer is the ignition loss itself of the second layer.

### (Other Components)

The second layer may contain a component other than the fiber-based flame retardant and the organic component. An example of such a component is an inorganic binder. The inorganic binder is not particularly limited, and examples thereof include alumina, silica, and metal alkoxide.

The upper limit of the thickness of the second layer is preferably 5 mm or less, more preferably 3 mm or less, and further preferably 1 mm or less. The lower limit of the thickness of the second layer can be 0.05 mm or 0.1 mm. When the thickness of the second layer is within the above-described rage, the laminate for sealing materials can be thinned.

### [1.2. First Layer] the First Layer Contains a Flame-Retardant Silicone Rubber Compound.

The flame-retardant silicone rubber compound is a silicone rubber composition that is imparted with flame retardancy by blending various additives to silicone rubber. In an embodiment, the flame-retardant silicone rubber compound has a flame retardancy of HB or higher in UL94 standards. That is, the flame-retardant silicone rubber compound has a flame retardancy of 5VA, 5VB, V-0, V-1, V-2, or HB in UL94 standards. In an embodiment, the flame-retardant silicone rubber compound has a flame retardancy of V-0 or higher in UL94 standards. That is, the flame-retardant silicone rubber compound has a flame retardancy of 5VA, 5VB, or V-0 in UL94 standards. In an embodiment, the flame-retardant silicone rubber compound has a flame retardancy of V-0 in UL94 standards.

The UL94 standards are standards for evaluating the flame retardancy of plastic products and widely adopted worldwide. The classes of UL94 standards include, in the descending order of flame retardancy, 5VA, 5VB, V-0, V-1, V-2, and HB. Since the test method of UL94 standards is known by persons skilled in the art, descriptions thereof will be omitted.

Examples of the silicone rubber contained in the flame-retardant silicone rubber compound include methyl silicone rubber, vinyl methyl silicone rubber, phenyl methyl silicone rubber, and fluorinated silicone rubber. These silicone rubbers may be contained individually or in combination of two or more. In an embodiment, the flame-retardant silicone rubber compound contains vinyl methyl silicone rubber. Examples of the additives contained in the flame-retardant silicone rubber compound include platinum, platinum compounds, iron oxide, triazole-based compounds, and aluminum hydroxide. These additives may be contained individually or in combination of two or more. Regarding a silicone rubber compound that falls under the flame-retardant silicone rubber compound, many commercial products are available, and many related patent literatures exist. Therefore, descriptions of the detailed composition of the flame-retardant silicone rubber compound will be omitted.

Examples of the flame-retardant silicone rubber compound having a flame retardancy of V-0 or higher in UL94 standards include Silastic™ SH502U, SH502U A/B, and SH1447UA (all manufactured by Dow Toray Co., Ltd.); KE-5620W-U, KE-5620BL-U, KE-5612E-U, KE-3494, KE3490, KE3467, KE-4890, KE-40RTV, KE-1831, KE-1867, KE-1891, KE-1204-LTV, KE-1292, KE-1800, and KE-1802 (all manufactured by Shin-Etsu Chemical Co., Ltd.); Elastosil® LR3011/50FR, LR3001/55FR, LR3001/60FR, and LR3170/40 (all manufactured by Wacker Asahikasei Silicone Co., Ltd.); and TSE2186U, TSE2183U, TSE2187U, TSE2184U, TCM5406U, and XE20-A7016 (all manufactured by Momentive Performance Materials Japan LLC). Examples of the flame-retardant silicone rubber compound having a flame retardancy of HB to V-1 in UL94 standards include Xiameter™ RBB-6630-30, RBB-6640-40, RBB-6650-50, RBB-6660-60, RBB-6670-70, RBB-6680-80, and RBB-6671-70 (all manufactured by Dow Toray Co., Ltd.); Silastic™ SE4704U, SE4705U, SE4706U, SE4708U, DY32-6014U, DY32-7040U, DY32-8013U, SRX495U, and DY32-502U (all manufactured by Dow Toray Co., Ltd.); KE-5634-U, KE-941-U, KE-951-U, KE-961-U, KE-971-U, KE-981-U, and KE-971T-U (all manufactured by Shin-Etsu Chemical Co., Ltd.); Elastosil® LR3003/(x), LR3004/(y), LR3005/(y), LR3065/(e), and LR3092/65BK (all manufactured by Wacker Asahikasei Silicone Co., Ltd.); and TSE221-3U, TSE221-4U, TSE221-5U, TSE221-6U, TSE221-7U, TSE221-8U, TSE2277U, XE20-523-4U, XE20-523-5U, TSE2181U, TCM5417U, TSE2911U, and TSE2971U (all manufactured by Momentive Performance Materials Japan LLC).

Examples of the patent literatures disclosing a silicone rubber compound that falls under the flame-retardant silicone rubber compound include JP-A-2004-149693, JP-A-2006-182911, and JP-A-2009-144024.

The first layer may contain a component other than the above-described components. Examples of such a component include a curing agent and various additives.

The curing agent is a component that imparts rubber elasticity to the first layer. Persons skilled in the art can appropriately select the curing agent depending on the reaction mechanism for imparting rubber elasticity. Examples of the reaction mechanism by the curing agent include a crosslink reaction, a condensation reaction, and an addition reaction.

In the case of imparting rubber elasticity to the first layer through an addition reaction, organohydrogen polysiloxane and a platinum-based catalyst can be used. Organohydrogen polysiloxane is a polyorganosiloxane in which the number of hydrogen atoms bound to a silicon atom per molecule is two or more on average.

The flame-retardant silicone rubber compound may contain oil. Of oil, silicone oil is preferable, and modified silicone oil is more preferable. Silicone oil is an oil that contains polyorganosiloxane as its main component. Modified silicone oil denotes a silicone oil in which a part of methyl groups contained in dimethyl silicone oil is substituted with another functional group. Examples of the modified silicone oil include amino-modified silicone oil, epoxy-modified silicone oil, carboxyl-modified silicone oil, carbinol-modified silicone oil, (meth)acrylic-modified silicone oil, mercapto-modified silicone oil, phenol-modified silicone oil, polyether-modified silicone oil, methylstyryl-modified silicone oil, alkyl-modified silicone oil, higher fatty acid ester-modified silicone oil, higher alkoxy-modified silicone oil, fluorine-modified silicone oil, and aralkyl-modified silicone oil. The modified silicone oil includes non-reactive modified silicone oil and reactive modified silicone oil. Among these, non-reactive modified silicone oil is preferable.

The first layer may contain various additives which are known in the technical field. Examples of such additives include reinforcing fillers (such as silica, diatomaceous earth, quartz powder, mica, and titanium oxide); extender fillers (such as diatomaceous earth, quartz powder, mica, clay, glass beads, and aluminum oxide); heat resistance improvers (such as carbon black, red iron oxide, alkali metal oxide, and alkaline earth metal oxide); and pigments.

### (Composition of First Layer)

With respect to the total weight of the first layer, the lower limit of the content ratio of the flame-retardant silicone rubber compound in the first layer is preferably 50% by weight or more, more preferably 80% by weight or more, and further preferably 90% by weight or more. The upper limit of the content ratio of the flame-retardant silicone rubber compound in the first layer can be, for example, 99.9% by weight or less.

When the first layer contains a rubber component other than silicone rubber, The ratio of silicone rubber to the entirety of the rubber component is preferably 50% by weight or more, more preferably 70% by weight or more, and further preferably 90% by weight or more. In an embodiment, the first layer does not contain a rubber component other than silicone rubber. Examples of the rubber component other than silicone rubber include fluorine rubber (FKM), natural rubber (NR), styrenebutadiene rubber (SBR), isoprene rubber (IR), butadiene rubber (BR), chloroprene rubber (CR), acrylonitrilebutadiene rubber (NBR), butyl rubber (IIR), ethylenepropylene rubber (EPM), ethylenepropylenediene rubber (EPDM), urethane rubber (U), ethylene acryl rubber (AEM), and acryl rubber (ACM).

The lower limit of the content of the oil in the first layer, with respect to the total weight of the first layer, is preferably 0.1% by weight or more, more preferably 0.3% by weight or more, and further preferably 0.5% by weight or more. When the content of the oil is less than 0.1% by weight, processability of the first layer may deteriorate. The upper limit of the content of the oil in the first layer, with respect to the total weight of the first layer, is preferably 15% by weight or less, more preferably 10% by weight or less, and further preferably 5% by weight or less. When the content of the oil exceeds 15% by mass, the first layer may be excessively soft or subject to bleeding.

In an embodiment, the first layer does not substantially contain the fiber-based flame retardant. The content of the fiber-based flame retardant in the first layer, when the content of the flame-retardant silicone rubber compound is 100 parts by weight, is preferably 1 part by weight or less, more preferably 0.5 part by weight or less, and further preferably 0.1 part by weight or less. In an embodiment, the first layer does not contain the fiber-based flame retardant.

Persons skilled in the art can appropriately set the blending amount of other components in the first layer according to the common technical knowledge. For example, the content of the curing agent, when the content of the flame-retardant silicone rubber compound is 100 parts by weight, can be 0.2 to 5.0 parts by weight.

### [1.3. Structure and Physical Properties of Laminate for Sealing Materials]

In the laminate for sealing materials, the first layer and the second layer may be in direct contact with each other. Alternatively, the laminate for sealing materials may include an adhesive layer disposed between the first layer and the second layer. FIG. 1 is a schematic view illustrating the outline structure of the laminate for sealing materials 10 in which the first layer 1 and the second layer 2 are in direct contact with each other. FIG. 2 is a schematic view illustrating an outline structure of a laminate for sealing materials 10a in which a first layer 1 and a second layer 2 are in contact with each other via an adhesive layer 3. The adhesive layer 3 is preferably excellent in flame retardancy. As described herein, a layer disposed between the first layer and the second layer in the laminate for sealing materials is generally referred to as an “adhesive layer”. In an embodiment, the adhesive layer contains a flame-retardant adhesive agent (such as an inorganic adhesive agent). An example of the inorganic adhesive agent is a silane coupling agent. Also, FIG. 1 and FIG. 2 illustrate a form in which the thickness of the second layer 2 is thinner than the thickness of the first layer 1. The thickness of the second layer 2 is not limited to this form and may be the same as or thicker than the thickness of the first layer 1.

In an embodiment, the laminate for sealing materials includes one first layer and two second layers. FIG. 3 is a schematic view illustrating an outline structure of a laminate for sealing materials 10b which includes a first layer 1 and two second layers 2a and 2b. In the laminate for sealing materials 10b, the second layer 2a and the second layer 2b are individually disposed on both surfaces of the first layer 1. The first layer 1 and the second layer 2a are in direct contact with each other, and the first layer 1 and the second layer 2b are in direct contact with each other. The compositions of the second layer 2a and the second layer 2b may be the same as or different from each other.

FIG. 4 is a schematic view illustrating an outline structure of a laminate for sealing materials 10c which includes a first layer 1, two second layers 2a and 2b, and two adhesive layers 3a and 3b. In the laminate for sealing materials 10c, the second layer 2a and the second layer 2b are individually disposed on both surfaces of the first layer 1. The adhesive layer 3a is disposed between the first layer 1 and the second layer 2a. The adhesive layer 3b is disposed between the first layer 1 and the second layer 2b. The compositions of the second layer 2a and the second layer 2b may be the same as or different from each other.

As a modification example, at least one of the adhesive layers 3a and 3b may not exist in the laminate for sealing materials 10c. That is, one of the second layers 2a and 2b may be in direct contact with the first layer 1.

The Shore A hardness of the laminate for sealing materials is preferably 85 or less and more preferably 80 or less. When the Shore A hardness is within the above-described range, it can be said that the laminate for sealing materials has a softness suitable as a sealing material. As described herein, the Shore A hardness is measured by a type A durometer based on JIS K6253 with the surface of the second layer as a measurement surface. It is noted that the measurement target of the Shore A hardness of the silicone rubber laminate is the silicone rubber laminate after curing in an ordinary state (in a state of not subjected to a flammability test).

The flame retardancy of the laminate for sealing materials according to an aspect of the present disclosure is improved compared to that of only a silicone rubber composition (that is, only the first layer). As described herein, “flame retardancy is improved” means that one or more, preferably both, of the following Condition 1 and Condition 2 are satisfied. The flame retardancy can be evaluated by a flammability test. For the method of performing a flammability test, see Examples described herein.
(Condition 1) Smoke occurrence time is delayed.
(Condition 2) Flame occurrence time is delayed, or flame does not occur.

### <<2. Sealing Material and Battery>>

A sealing material according to an embodiment of the present disclosure contains the above-described laminate for sealing materials. As described herein, the sealing material refers to a molded product used by being disposed between two or more members. The two or more members may be members which change in their relative position or may be members which do not change in their relative position. The sealing material has the function of, for example, sealing (suppressing) the movement of fluid (gas, liquid, or a mixture thereof).

The uses of the sealing material are not particularly limited. Since the flame retardancy of the sealing material according to an embodiment of the present disclosure is improved, this sealing material is preferably used for a product required to have flame retardancy. Examples of such a product include a battery, a vehicle, a housing material, a household appliance, and a mobile terminal.

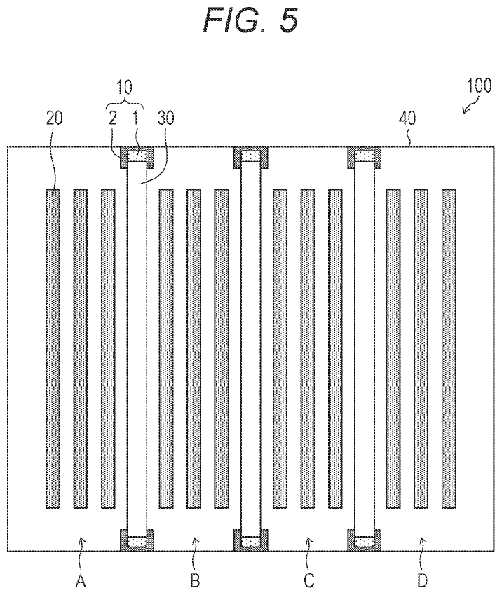

Hereinafter, a use example when the sealing material according to an embodiment of the present disclosure is applied to a battery will be described with reference to FIG. 5. A battery 100 includes a sealing material 10 (the laminate for sealing materials 10), two or more cells 20, a heat insulating material 30, and a container 40. The battery 100 is configured to draw power from the two or more cells 20 (from twelve cells 20 in FIG. 5). It is noted that in FIG. 5, a member for drawing power from the cells 20 is omitted. A specific example of the battery 100 is a non-aqueous electrolyte secondary battery (such as a lithium ion secondary battery).

The sealing material 10 is the sealing material according to an aspect of the present disclosure. The cells 20 are each a packaged power generation element that contains a positive electrode, a negative electrode, a separator, and an electrolytic solution. The heat insulating material 30 is a member that suppresses the transmission of heat generated in the cells 20 to other portions. The container 40 is a member that houses the sealing material 10, the cells 20, and the heat insulating material 30. That is, the two or more cells 20, the heat insulating material 30, and the sealing material 10 are housed in the container 40.

The inside of the container 40 is divided into two or more compartments by the heat insulating material 30. That is, the heat insulating material 30 is disposed to divide the inside of the container 40 into two or more compartments. In FIG. 5, the inside of the container 40 is divided into four compartments of compartment A, compartment B, compartment C, and compartment D. The two or more existing cells 20 are disposed to be divided into two or more of the two or more compartments. In FIG. 5, the cells 20 are disposed in all of four compartments A to D, but there may be a compartment in which the cells 20 are not disposed. The sealing material 10 is disposed to block a void (gap) between the heat insulating material 30 and the container 40. Further, the sealing material 10 is disposed such that the first layer 1 is in contact with the heat insulating material 30. Since the first layer 1 is relatively softer than the second layer 2, it can also follow the positional change of the heat insulating material 30. This improves the sealing properties of the sealing material 10. On the other hand, the second layer 2 is disposed to interrupt between A to D and the first layer 1. Accordingly, the second layer 2 can prevent the first layer 1 from coming into contact with flame.

For example, when the cells 20 disposed in compartment A fail and catch fire, the sealing material 10 and the heat insulating material 30 suppress the spread of fire into compartment B. The sealing material 10 is the sealing material according to an embodiment of the present disclosure. Therefore, the flame retardancy of the sealing material 10 is improved compared to a sealing material as an existing product. In addition, the sealing material 10 also retains elongation after burning. Therefore, the safety of the battery 100 is improved compared to an existing battery.

### <<3. Production Method of First Layer, Second Layer, and Laminate for Sealing Materials>>

The production method of the first layer is not particularly limited. For example, the first layer can be produced by kneading and curing a first composition that contains the components described in section [1.2]. For the kneading of the components, a kneading machine can be used. Examples of the kneading machine include an open roll, a kneader, a planetary mixer, a Banbury mixer, and an extruder. The kneading temperature may be 25 to 200° C. The kneading time may be 1 minute to 1 hour. The curing temperature may be 25 to 200° C. The curing time may be 10 seconds to 120 minutes.

The second layer can be produced by, for example, sheet-making the fiber-based flame retardant or solidifying the fiber-based flame retardant with a binder. Alternatively, a commercially available product may be used as the second layer. Examples of the commercially available product include Superwool Plus, Superwool HT, and Superwool HT-I (all manufactured by Shin-Nippon Thermal Ceramics Corporation); and heat-resistant rock wool paper, AES paper, and alumina fiber paper (all manufactured by Tomoegawa Co., Ltd.).

The method for laminating the first layer and the second layer is not particularly limited. In an embodiment, the first layer and the second layer are laminated by insert molding. That is, in this case, the first layer and the second layer are integrally molded by insert molding. In an embodiment, the first layer and the second layer are laminated by molding a first layer and thereafter bonding a second layer to the first layer via an adhesive layer. That is, in this case, the production method of a laminate for sealing materials includes molding a first layer and bonding the first layer and a second layer via an adhesive layer. The first layer and the second layer are integrally molded via the adhesive layer.

The cured first layer may be subjected to secondary curing. The secondary curing temperature may be 25 to 250° C. The secondary curing time may be 30 minutes to 4 hours.

### 4. Conclusion

An embodiment of the present disclosure includes the following constituents.

<1>

A laminate for sealing materials (10, 10a, 10b, 10c) including a first layer (1) that contains a flame-retardant silicone rubber compound and a second layer (2, 2a, 2b) that contains a fiber-based flame retardant, in which a content of an organic component in the second layer (2, 2a, 2b) is 0 to 10% by weight.

<2>

The laminate for sealing materials (10, 10a, 10b, 10c) according to <1>, in which the second layer (2, 2a, 2b) has a thickness of 5 mm or less.

<3>

The laminate for sealing materials (10, 10a, 10b, 10c) according to <1> or <2>, in which the flame-retardant silicone rubber compound has a flame retardancy of V-0 or higher in UL94 standards.

<4>

The laminate for sealing materials (10, 10a, 10b, 10c) according to any of <1> to <3>, in which the fiber-based flame retardant contains one or more selected from the group consisting of artificial mineral fiber and natural mineral fiber.

<5>

The laminate for sealing materials (10, 10a, 10b, 10c) according to <4>, in which the fiber-based flame retardant contains the artificial mineral fiber, and the artificial mineral fiber contains one or more selected from the group consisting of AES wool, rock wool, and alumina fiber.

<6>

The laminate for sealing materials (10, 10a, 10b, 10c) according to any of <1> to <5>, in which a content ratio of the flame-retardant silicone rubber compound in the first layer (1) is 50% by weight or more.

<7>

The laminate for sealing materials (10, 10a, 10b, 10c) according to any of <1> to <6>, in which the first layer (1) and the second layer (2, 2a, 2b) are integrally laminated by insert molding.

<8>

The laminate for sealing materials (10, 10a, 10b, 10c) according to <1>, in which the first layer (1) and the second layer (2, 2a, 2b) are integrally molded via an adhesive layer (3, 3a, 3b).

<9>

A production method of a laminate for sealing materials (10, 10a, 10b, 10c), including molding a first layer (1) and bonding the first layer (1) and a second layer (2, 2a, 2b) via an adhesive layer (3, 3a, 3b), in which the first layer (1) contains a flame-retardant silicone rubber compound, the second layer (2, 2a, 2b) contains a fiber-based flame retardant, and a content of an organic component in the second layer (2, 2a, 2b) is 0 to 10% by weight.

<10>

A sealing material (10, 10a, 10b, 10c), including the laminate for sealing materials (10, 10a, 10b, 10c) according to any one of <1> to <8>.

<11>

A battery (100) including two or more cells (20), a heat insulating material (30), a container (40), and the sealing material (10, 10a, 10b, 10c) according to <10>, in which the two or more cells (20), the heat insulating material (30), and the sealing material (10, 10a, 10b, 10c) are housed in the container (40), the heat insulating material (30) is disposed to divide the inside of the container (40) into two or more compartments, the two or more cells (20) are disposed to be divided into two or more of the two or more compartments, and the sealing material (10, 10a, 10b, 10c) is disposed to block a gap between the heat insulating material (30) and the container (40) and such that the first layer (1) is in contact with the heat insulating material (30).

### EXAMPLES

Hereinafter, an embodiment of the present disclosure will be more specifically described by examples. However, the technology of the present disclosure is not limited to these examples.

### [Used Materials]

Flame-retardant silicone rubber compound
Flame-retardant silicone rubber compound (KE-5612E-U, Shin-Etsu Chemical Co., Ltd., vinyl methyl silicone rubber-based compound, UL94 standard: V-0)
Heat insulating sheet
Heat insulating sheet 1 (Superwool HT-I, Shin-Nippon Thermal Ceramics Corporation, ignition loss: 4% by weight, thickness: 0.25 mm, obtained by sheet-making fiber that contains SiO₂, CaO, and MgO)
Heat insulating sheet 2: (heat-resistant rock wool paper, Tomoegawa Co., Ltd., ignition loss: 5.7% by weight, thickness: 0.85 mm, obtained by making a sheet from heat-resistant rock wool)
Heat insulating sheet 3: (AES paper, Tomoegawa Co., Ltd., ignition loss: 6.2% by weight, thickness: 1.0 mm, obtained by making a sheet from AES fiber)
Curing agent
Curing agent (C-3, Shin-Etsu Chemical Co., Ltd., dicumyl peroxide)

### Examples 1 to 3

A laminate that contains a vulcanized rubber sheet and a heat insulating sheet was prepared by insert molding according to the following procedure. This laminate is a material from which a test piece is prepared in the later-described test.
1. The components of the first layer described in Table 1 were kneaded by an open roll. The kneading temperature was 20 to 100° C. The kneading time was 10 to 30 minutes.
2. With the obtained kneaded product, an unvulcanized rubber sheet to become the first layer was prepared.
3. As the second layer, the heat insulating sheet described in Table 1 was used. The heat insulating sheet was placed in a sheet die having a depth of 1 to 3 mm, and the unvulcanized rubber sheet to become the first layer was layered on the heat insulating sheet. A sheet die having a different depth was used such that the thickness of the first layer became 1 mm, depending on the thickness of the used heat insulating sheet.
6. The unvulcanized rubber sheet to become the first layer was subjected to press vulcanization at 165° C. for 10 minutes.
7. Furthermore, secondary vulcanization was performed at 200° C. for 4 hours. In this manner, there was obtained a laminate in which a vulcanized rubber sheet (thickness: 1 to 3 mm) as the first layer and a heat insulating sheet as the second layer are laminated.

### Comparative Example 1

According to the following procedure, there was prepared a vulcanized rubber sheet in which a heat insulating sheet is not laminated. This sheet is a material from which a test piece is prepared in the later-described test.
1. The components of the first layer described in Table 1 were kneaded by an open roll. The kneading temperature was 20 to 100° C. The kneading time was 10 to 30 minutes.
2. With the obtained kneaded product, an unvulcanized rubber sheet was prepared.
3. The unvulcanized rubber sheet was subjected to press vulcanization at 165° C. for 10 minutes.
4. Furthermore, secondary vulcanization was performed at 200° C. for 4 hours. In this manner, a vulcanized rubber sheet (thickness: 1 to 3 mm) was obtained.

### [Test Method]

A test piece was subjected to a flammability test to evaluate flame retardancy. The specific procedure is as described below.
1. From a 2 mm-thick vulcanized rubber sheet laminate or vulcanized rubber sheet, a sheet of 15 mm in width×100 mm in length was cut out, and the cut out sheet was used as a test piece.
2. The test piece was fixed to a jig, and the flame of a burner was adjusted such that the temperature at the burning site in the test piece became 800° C.
3. Flame was applied to the test piece for 2 minutes. At this time, the time (sec) of the occurrence of smoke and the time (sec) of the occurrence of flame were recorded with the time of starting the application of flame as 0 second. The recorded results are illustrated in Table 1.

For the test piece after subjected to a flammability test, presence or absence of deformation was visually determined, and evaluation was made based on the following four levels. The evaluation results are illustrated in Table 1.
4 . . . No deformation or minor deformation
3 . . . Small deformation
2 . . . Moderate deformation
1 . . . Large deformation

Additionally, for the test piece after subjected to a flammability test, the appearance was visually determined, and evaluation was made based on the following four levels. The evaluation results are illustrated in Table 1.
4 . . . Very good: only whitening without cracking, or minute cracking
3 . . . Good: small to moderate cracking
2 . . . Average: large cracking
1 . . . Poor: multiple fractures, peelings, breaks, and/or crushes

TABLE 1

| | | | | | | Comparative |
|---|---|---|---|---|---|---|
| | | | Example 1 | Example 2 | Example 3 | Example 1 |
| First layer | Flame-retardant silicone | wt % | [symbol] | [symbol] | [symbol] | [symbol] |
| | rubber compound | | | | | |
| | Curing agent | wt % | [symbol] | [symbol] | [symbol] | [symbol] |
| Second | Heat insulating sheet 1 | Thickness (mm) | [symbol] | — | — | — |
| layer | Heat insulating sheet 2 | Thickness (mm) | — | [symbol] | — | — |
| | Heat insulating sheet 3 | Thickness (mm) | — | — | [symbol] | — |
| Evaluation | Smoke occurrence time | Sec | [symbol] | [symbol] | [symbol] | 15 |
| | Flame occurrence time | Sec | [symbol] | [symbol] | [symbol] | 15 |

| | | | | |
|---|---|---|---|---|
| Deformation | 4 | 4 | 4 | 2 |
| Appearance | 4 | 4 | 4 | 1 |

*Flame had not occurred at the time of 120 sec after start of flame application. [symbol]
indicates data missing or illegible when filed

### [Results]

When Examples 1 to 3 are compared to Comparative Example 1, it is understood that the provision of the second layer improves flame retardancy. That is, the smoke occurrence times of Examples 1 to 3 were later than the smoke occurrence time of Comparative Example 1. Also, regarding the occurrence of flame, flame did not occur until the end of a test in Examples 1 to 3. On the other hand, flame occurred 15 seconds after the start of a test in Comparative Example 1.

Also, a comparison on the deformation and appearance of the test piece after burning demonstrated that the sealing materials according to Examples 1 to 3 exhibited better characteristics than the sealing material according to Comparative Example 1.

In the Examples, a heat insulating sheet was used as the second layer. As described in item [Used materials], these heat insulating sheets have an ignition loss of 10% by weight or less. Therefore, it can be said that the content of an organic component of these heat insulating sheets is also 10% by weight or less. The use of such a material as the second layer drastically improved flame retardancy in the laminate for sealing materials according to an embodiment of the present disclosure.

### INDUSTRIAL APPLICABILITY

The technology of the present disclosure can be used for, for example, sealing materials included in batteries and others.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A laminate for sealing materials comprising:
a first layer that contains a flame-retardant silicone rubber compound; and
a second layer that contains a fiber-based flame retardant,
wherein a content of an organic component in the second layer is 0 to 10% by weight.

2. The laminate for sealing materials according to claim 1,
wherein the second layer has a thickness of 5 mm or less.

3. The laminate for sealing materials according to claim 1,
wherein the flame-retardant silicone rubber compound has a flame retardancy of V-0 or higher in UL94 standards.

4. The laminate for sealing materials according to claim 1,
wherein the fiber-based flame retardant contains one or more selected from the group consisting of artificial mineral fiber and natural mineral fiber.

5. The laminate for sealing materials according to claim 4, wherein
the fiber-based flame retardant contains the artificial mineral fiber, and
the artificial mineral fiber contains one or more selected from the group consisting of AES wool, rock wool, and alumina fiber.

6. The laminate for sealing materials according to claim 1,
wherein a content ratio of the flame-retardant silicone rubber compound in the first layer is 50% by weight or more.

7. The laminate for sealing materials according to claim 1,
wherein the first layer and the second layer are integrally molded by insert molding.

8. The laminate for sealing materials according to claim 1,
wherein the first layer and the second layer are integrally molded via an adhesive layer.

9. A production method of a laminate for sealing materials comprising:
molding a first layer; and
bonding the first layer and a second layer via an adhesive layer, wherein
the first layer contains a flame-retardant silicone rubber compound,
the second layer contains a fiber-based flame retardant, and
a content of an organic component in the second layer is 0 to 10% by weight.

10. A sealing material comprising the laminate for sealing materials according to claim 1.

11. A battery comprising:
two or more cells;
a heat insulating material;
a container, and
the sealing material according to claim 10, wherein
the two or more cells, the heat insulating material, and the sealing material are housed in the container,
the heat insulating material is disposed to divide an inside of the container into two or more compartments,
the two or more cells are disposed to be divided into two or more of the two or more compartments, and
the sealing material is disposed to block a gap between the heat insulating material and the container and such that the first layer is in contact with the heat insulating material.
